(19) United States
(12) Patent Application Publication
(10) Pub. No.: US 2020/0362287 A1
(43) Pub. Date: Nov. 19, 2020

(54) BOTTLE FOR STORING AND AGING BEVERAGES

(71) Applicant: Revenge Rum LLC, West Palm Beach, FL (US)

(72) Inventor: Christopher C. Bolt, West Palm Beach, FL (US)

(21) Appl. No.: 16/874,620

(22) Filed: May 14, 2020

Related U.S. Application Data
(60) Provisional application No. 62/848,847, filed on May 16, 2019.

(51) Int. Cl. C12H 1/22; C12G 3/07; B65D 8/00

(52) U.S. Cl. CPC C12H 1/22; B65D 9/04; C12G 3/07

(57) ABSTRACT

A wooden bottle for storing and aging a beverage, includes a bottle body comprising a plurality of curved wooden staves arranged to form a barrel shape for the bottle body, a neck at one end of the bottle body, and a bottom cap at the opposite end of the bottle body. A spacing between adjacent curved wooden staves is configured to permit an exchange of gas between the content of the wooden bottle and the environment outside the wooden bottle to enhance aging of the beverage.

### CROSS-REFERENCE TO RELATED APPLICATIONS

This application claims the benefit of U.S. Provisional Application 62/848,847, filed on May 16, 2019, the entirety of which is expressly incorporated herein by reference thereto.

### FIELD OF THE INVENTION

Embodiments of the present invention relate to storage container for beverages. Specifically, embodiments of the present invention relate to wooden bottles for storing and aging beverages.

### BACKGROUND

Aging is an essential part of the process of producing many beverages, including alcoholic beverages such as beer, wine, cider, liquor, and other spirits. The aging process allows the beverage to mature and acquire or enhance taste, flavor, aroma, scent, and color characteristics that are considered more pleasant for consumption. Typically, the beverages to be aged are kept in large containers at or near the distillery or brewery sites. The containers may be made of large casks or barrels of wood, such as oak. The aging process involves the interaction of the content of the containers with the wood. In particular, the resting spirit absorbs various chemicals and flavors such as tannins or lignin from the wood through prolonged contact with the interior surface of the barrel. The interior surface of the barrel is often toasted and/or charred to prime the wood, alter the substances therein, and facilitate their transfer to the spirit. Wooden barrels may also serve to aerate the liquid by providing pathways to exchange air between the content of the barrel and the outside, which smooths out the taste of the spirit.

The aging process stops when the spirit is transferred from wooden barrels to glass bottles, metal cans, or paper cartons that are typically used to store beverages for consumer consumption. As a result, a traditionally packaged spirit remains relatively inert during the time (sometimes years) in the supply chain from the production facility to the consumer. It would be desirable to provide a portable container that can enable the continued aging of the beverages during transit from the distillery to the consumer's glass—for example while stored in a wholesaler's warehouse, on a retailer's shelves, or in the consumer's cabinet.

### SUMMARY OF THE INVENTION

Embodiments of the present invention disclose a wooden bottle for storing and aging a beverage. The wooden bottle includes a bottle body that includes a plurality of curved wooden staves arranged to form a barrel shape for the bottle body, a neck at one end of the bottle body, and a bottom cap at the opposite end of the bottle body, wherein a spacing between adjacent curved wooden staves is configured to permit an exchange of gas between the content of the bottle and the environment outside the bottle to enhance aging of the beverage.

In some embodiments, the wooden bottle has a capacity between about 700 mL and about 2 L.

In certain embodiments, the curved wooden staves are curved outwardly along the longitudinal axis of the bottle to form a bilge on the bottle body.

In some embodiments, the curved wooden staves are curved along a circumference of the bottle.

In certain embodiments, the curved wooden staves comprise one or more pieces of wood that have been carved to form a curved wooden stave.

In some embodiments, the wood of the curved wooden staves is treated with heat to facilitate aging of the content of the wooden bottle.

In some embodiments, the wood of the curved wooden staves is treated with open flame to facilitate aging of the content of the wooden bottle.

In certain embodiments, a hot fluid, hot gas, or a combination thereof is transferred into the bottle body to cause the curved wooden staves to expand to seal the seams between adjoining curved wooden staves from leaks of the content of the wooden bottle.

In some embodiments, the curved wooden staves are configured to allow passage of a gas through the wood of the curved wooden staves.

In certain embodiments, the curved wooden staves are carved from oak.

Embodiments of the present invention also disclose a method of providing a wooden bottle for storing and aging a beverage. The method includes arranging a plurality of curved wooden staves to form a barrel shape for a bottle body, providing a neck at one end of the bottle body, and providing a bottom cap at the opposite end of the bottle body, wherein a spacing between adjacent curved wooden staves is configured to permit an exchange of gas between the content of the bottle and the environment outside the wooden bottle to enhance aging of the beverage.

In some embodiments, the wooden bottle has a capacity between about 700 mL and about 2 L.

In certain embodiments, the curved wooden staves are curved outwardly along the longitudinal axis of the bottle to form a bilge on the bottle body.

In some embodiments, the curved wooden staves are curved along a circumference of the wooden bottle.

In certain embodiments, the method further includes carving individual pieces of wood to form individual curved wooden staves.

In certain embodiments, the method further includes treating the wood of the curved wooden staves with heat to facilitate aging of the content of the bottle.

In some embodiments, the method further includes treating the wood of the curved wooden staves with open flame to facilitate aging of the content of the bottle.

In some embodiments, the method further includes transferring a hot fluid, hot gas, or a combination thereof into the bottle body to cause the curved wooden staves to expand to seal the seams between adjoining curved wooden staves from leaks of the content of the wooden bottle.

In certain embodiments, the curved wooden staves are configured to allow passage of a gas through the wood of the curved wooden staves.

In some embodiments, the method further includes carving the curved wooden staves from oak.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1 illustrates perspective view of an exemplary bottle, according to an embodiment of the present invention.

FIG. 2 illustrates a side view of an exemplary bottle, according to an embodiment of the present invention.

FIG. 3 illustrates an exploded view of an exemplary bottle, according to an embodiment of the present invention.

FIG. 4 illustrates a top view of an exemplary bottle, according to an embodiment of the present invention.

FIG. 5 illustrates a bottom view of an exemplary bottle, according to an embodiment of the present invention.

Certain examples and embodiments have other features that are one of in addition to and in lieu of the features illustrated in the above-referenced figures. These and other features are detailed below with reference to the above-referenced figures.

### DETAILED DESCRIPTION OF THE INVENTION

The present system and method will be described in connection with the figures, it being understood that the description and figures are for illustrative, non-limiting purposes.

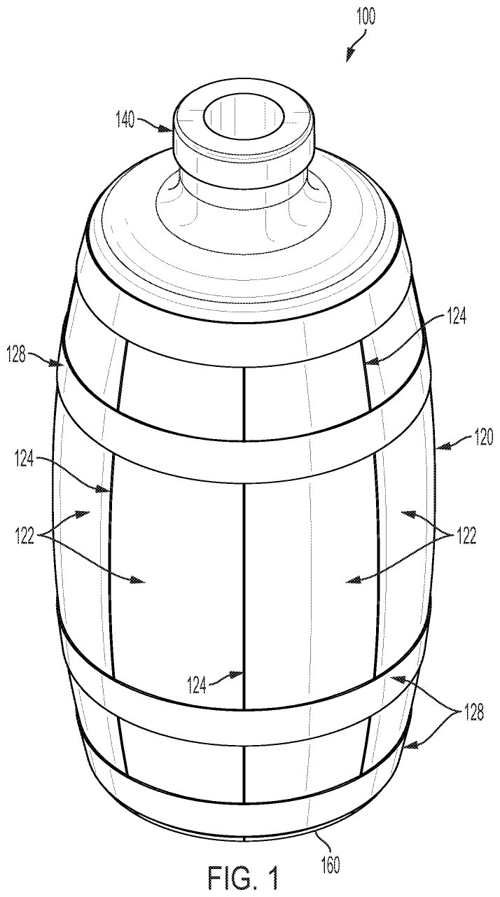

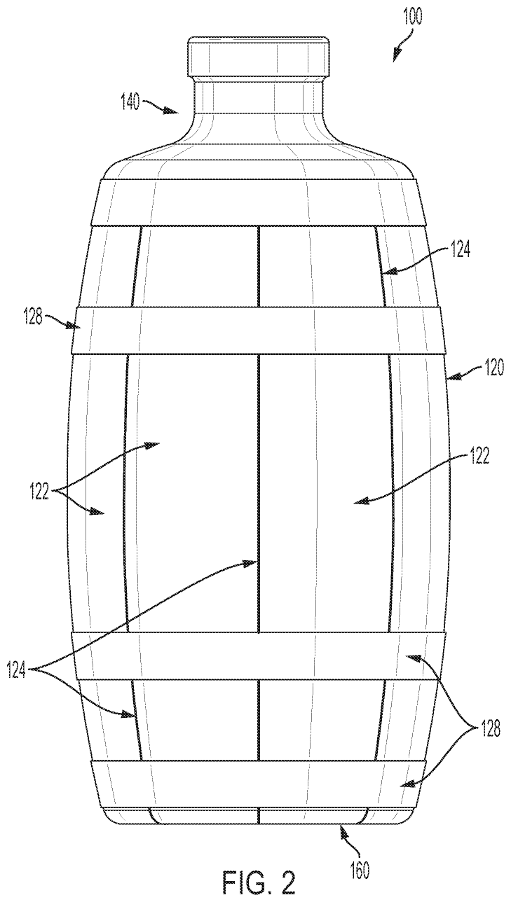

According to embodiments of the present invention, a wooden bottle 100 for storing and aging a beverage is disclosed. A wooden bottle means that the bottle is made substantially only with wood (e.g., 90% of the structure of the bottle is wood). For illustrative purposes the diagram and discussion are directed to a wooden bottle but it is understood that a bottle that comprises wood but not the same level of use is contemplated. FIG. 1 illustrates perspective view of an exemplary wooden bottle 100 according to an embodiment of the present invention. FIG. 2 illustrates a side view of an exemplary wooden bottle 100 according to an embodiment of the present invention. The wooden body 100 comprises a bottle body 120, a bottle neck 140, and a bottom cap 160. The wooden bottle 100 may have a variety of shapes. In a preferred embodiment, the wooden bottle 100 may be shaped as an elongated barrel. In some embodiments, the wooden bottle 100 may have a size comparable to that of a retail bottle for liquor or wine. As such, the wooden bottle 100 may have a capacity between about 700 milliliters and about 2 liters, in some examples. Consistent with this capacity, the wooden bottle 100 may be between 8 to 12 inches tall and between 3 and 5 inches in diameter, depending on the capacity of the bottle. This is an illustrative example and other sizes are contemplated.

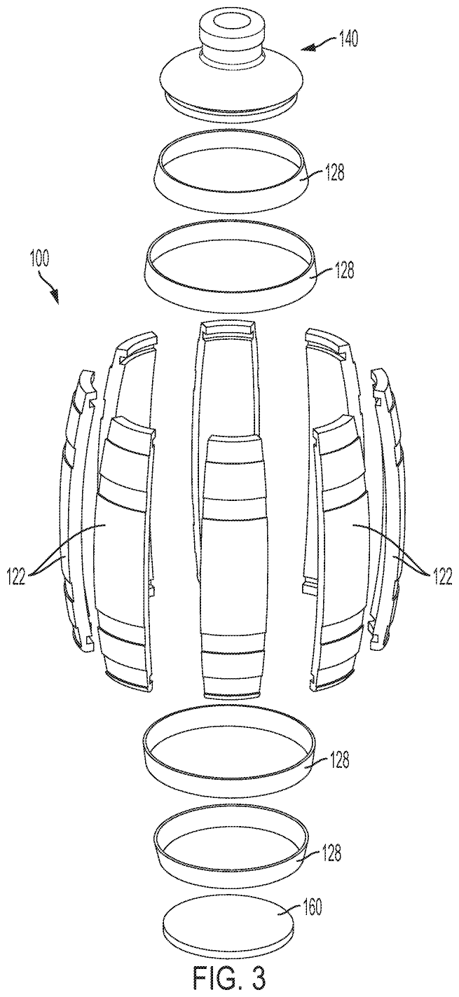

The bottle body 120 comprises a plurality of curved wooden staves 122. FIG. 3 illustrates an exploded view of the bottle 100, according to an embodiment of the present invention. As illustrated in FIG. 3, each curved wooden stave 122 is an elongated, curved piece of wood. A stave 122 of the plurality is curved along its length. In some embodiments, the curved wooden stave 122 may also exhibit a curve along its width corresponding to an arc of a circumference of the bottle body 120. In a preferred embodiment, the curves of the curved wooden staves 122 result from their carving from a larger piece of wood, rather than a straight piece of wood that is bent to form a curve along the length of the stave. The curved wooden staves 122 may be arranged vertically and the sides of each vertical curved wooden stave 122 be joined with that of two adjacent curved wooden staves 122 to form the bottle body 120 around a longitudinal axis of the bottle 100. The curved wooden staves 122 forming the bottle body 120 may, for example, number between six and twelve, depending on the embodiment.

In some embodiments, curved wooden staves 122 of the same proportional size and shape can be used to form bottle bodies (and therefore bottles) of different sizes. For example, in FIG. 3, the bottle body comprises eight curved wooden staves 122. A smaller number of the same curved wooden staves 122 (e.g., six) may be used to build a smaller bottle than the bottle of FIG. 3. Similarly, a greater number of the same curved wooden staves 122 (e.g., twelve) may be assembled to form a larger wooden bottle than in FIG. 3. The curved wooden staves 122 may thus be configured to provide the flexibility to scale up or down the size of the bottle by varying their number.

In some embodiments, the curved wooden staves 122 are secured together using a wax such as paraffin wax. In some embodiments, curved wooden staves 122 are held together with one or more metal hoops 128, as illustrated in FIGS. 1, 2, and 3. The metal hoops 128 are spaced apart along the length of the outer surface of the bottle body 120. The wooden bottle 100 depicted in FIGS. 1-3 features four metal hoops 128. However, the number of metal hoops 128 may vary from a single metal hoop to more than half a dozen, depending on the embodiment. In some embodiments, circumferential notches are provided on the outer surface of the bottle body 120 to accommodate the metal hoops 128 and help secure the curved wooden staves 122 together.

The curved wooden staves 122 may be carved from any wood appropriate for aging beverages. Examples of wood used for this purpose include most commonly French and American oak, but also hickory, maple, redwood, and many other types of wood depending on the flavor characteristics desired.

In some embodiments, the curved wooden staves 122 of the plurality may be treated to enhance or accelerate the aging process. Various degrees of heat may be applied to the wood prior to or after assembly of the wooden bottle 100, using various methods, with the purpose of priming the wood for interaction with the stored liquid. For example, an interior surface of the curved wooden staves 122 may be charred with direct flame; the process of charring the wood may caramelize the sugars in the wood, for example. Charring may also break down certain compounds such as lignin, hemicellulose, and others, into the wood. This facilitates the extraction of flavor from the wood into the liquid, which is an integral part of the aging process. Contact with charred wood also darkens the color of the enclosed spirit over time. The wood of the curved wooden staves 122 may also be toasted with indirect heat such as hot air, resulting in a milder effect on the wood and consequently on the stored liquid. For example, toasted wood may provide less color to a spirit than charred wood. Toasting the wood may also preserve certain accents in the wood that may be destroyed by the harsher treatment of charring the wood.

In some embodiments, the junctions or seams 124 between the wooden staves 122 of the plurality are configured to enable a limited exchange of air or other gas between the content of the wooden bottle 100 and the environment outside of the bottle. This permits the liquid within the wooden bottle 100 to be aerated, which alters the character of the spirit in desirable ways, such as providing a smoother taste.

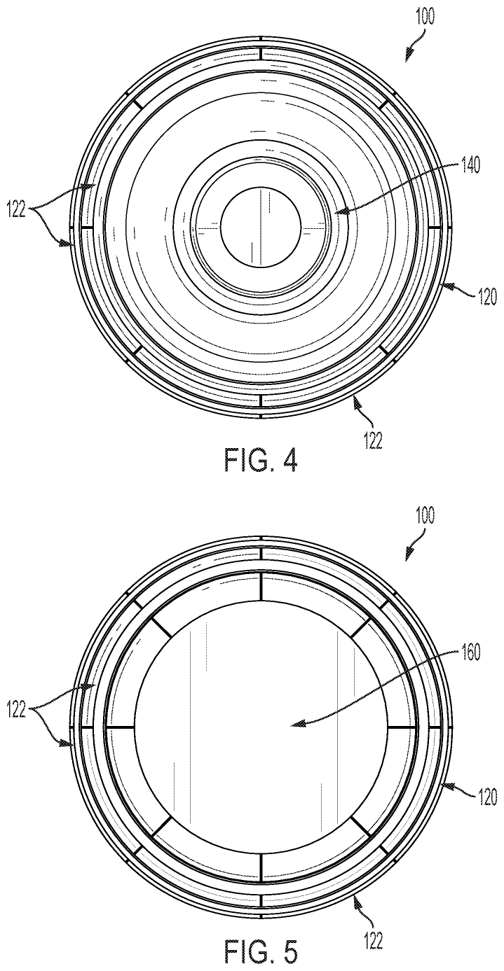

FIG. 4 illustrates a top view of an exemplary wooden bottle 100, according to an embodiment of the present invention. As illustrated in the figure, the wooden bottle 100 further comprises a neck 140, which enables the flow of liquid in and out of the wooden bottle 100. The bottle body 120 is closed at the opposite end by the cap 160. FIG. 5 illustrates a bottom view of an exemplary wooden bottle 100, according to an embodiment of the present invention. The cap 160 is typically a circular disk made of wood, metal, plastic, or any other suitable material. Where the cap is made of wood, it may be treated to enhance aging, for example with heat, as described above for the curved wooden staves 122. The cap 160 may be secured to the bottle body 120 with paraffin wax or another other appropriate fastening means.

The wooden bottle 100 allows the stored beverage to continue aging while it is stored with the retailer or consumer. The barrel shape of the bottle body 120 replicates the advantages inherent to the same shape with larger, traditional aging barrels. The wooden bottle 100 further provides a greater degree of aging to the quantity of beverage stored within compared to the same quantity of the same beverage stored in a large traditional barrel because the smaller size of the wooden bottle 100 increases the surface of contact between the stored beverage and the treated wood. The greater surface of contact increases the exchange of aroma between the beverage and the treated wood and accelerates the aging process over traditional barrels.

As shown, the neck 140 and opening for pouring the beverage is positioned to be at the center of the bottle 100. The neck 140 and top of bottle 100 are preferably made of wood such as the same wood (e.g., treated wood) used for the curved wooden staves 122.

If desired, the structure of the bottle can include materials other than wood such as by having a different type of material on an exterior surface of the bottle. The structure would continue to provide for direct contact of the beverage with the wood in the interior of the bottle that continues to age the beverage.

As discussed, bottle 100 is configured to allow an exchange or release of gases from the bottle 100 which is part of the aging process. In this embodiment, the bottle is configured to allow for the gas to leave the bottle 100 from seams 124 between adjoining curved wooden staves 122, as well as through the curved wooden staves themselves. The bottle 100 is adapted to have curved wooden staves 122 form a junction 124 (plurality of junctions in the bottle) that is tight enough to allow gas to pass through and not allow for beverage to leak through the seam 124.

In some embodiments, when bottle 100 is constructed, steam, hot water or another fluid and/or gas is poured into the bottle and retained in the bottle for a sufficient period to allow the interior walls of the curved wooden staves 122 to swell to form the tight fit at the seams 124 between curved wooden staves 122 that permits the desired flow of gases without allowing liquid to leak through.

It should be understood that a cap, plug, or cork is used to close the opening at the top of the bottle after the bottle is filled with a beverage and is used for keeping the liquid in the bottle (e.g., during transport) and limiting the amount of air that is exposed to the beverage (e.g., the bottle owner will close the bottle top after using).

Bottle 100 can be mass produced and filled at a brewery. The bottles can be easily shipped to destinations such as restaurants, stores, or consumer homes. A bottle can be placed on a shelf, surface, or rack at the destination without requiring any special equipment to allow the bottle to continue to apply the aging process to the beverage. If the type of beverage requires refrigeration or a certain temperature, that can be applied by such related equipment.

The bottle 100 is portable due to its size and shape that permits an individual to keep the bottle for long term personal use without requiring a significant amount of space for storage (e.g., in preferred embodiments it is adapted to be approximately within the range of the sizes of conventional liquor or wine bottles for consumer use).

The bottle 100 can be particularly suited for use with rum, whiskey, scotch, brandy, bourbon, or other types of hard liquor that are typically distributed with various degrees of aging to intentionally enhance the beverage.

The bottle can be used for different storing (and pouring) other types of liquids or beverages. If desired, the bottle made of other material such as glass, plastic, or combinations of material. In such embodiments, the bottle may or may not be configured to allow for aging, involving the release of gases, from inside the bottle. The bottle may also be made of single piece (e.g., a single piece of wood) or some other combination of wood pieces.

It should be understood that combinations of described features or steps are contemplated even if they are not described directly together or not in the same context.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

It should be understood that the above-described examples are merely illustrative of some of the many specific examples that represent the principles described herein. Clearly, those skilled in the art can readily devise numerous other arrangements without departing from the scope as defined by the following claims.

1. A wooden bottle for storing and aging a beverage, comprising:
a bottle body comprising a plurality of curved wooden staves arranged to form a barrel shape for the bottle body,
a neck at one end of the bottle body, and
a bottom cap at the opposite end of the bottle body,
wherein a spacing between adjacent curved wooden staves is configured to permit an exchange of gas between the content of the wooden bottle and the environment outside the wooden bottle to enhance aging of the beverage.

2. The wooden bottle of claim 1, wherein the wooden bottle has a capacity between about 700 mL and about 2 L.

3. The wooden bottle of claim 1, wherein the curved wooden staves are curved outwardly along the longitudinal axis of the wooden bottle to form a bilge on the bottle body.

4. The wooden bottle of claim 1, where the curved wooden staves are curved along a circumference of the wooden bottle.

5. The wooden bottle of claim 1, wherein the curved wooden staves comprises one or more pieces of wood that have been carved to form a curved wooden stave.

6. The wooden bottle of claim 1, wherein the wood of the curved wooden staves is treated with heat to facilitate aging of the content of the wooden bottle.

7. The wooden bottle of claim 1, wherein the wood of the curved wooden staves is treated with open flame to facilitate aging of the content of the wooden bottle.

8. The wooden bottle of claim 1, wherein a hot fluid, hot gas, or a combination thereof is transferred into the bottle body to cause the curved wooden staves to expand to seal the seams between adjoining curved wooden staves from leaks of the content of the wooden bottle.

9. The wooden bottle of claim 1, wherein the curved wooden staves are configured to allow passage of a gas through the wood of the curved wooden staves.

10. The wooden bottle of claim 1, wherein the curved wooden staves are carved from oak.

11. A method of providing a wooden bottle for storing and aging a beverage, the method comprising:
arranging a plurality of curved wooden staves to form a barrel shape for a bottle body,
providing a neck at one end of the bottle body, and
providing a bottom cap at the opposite end of the bottle body,
wherein a spacing between adjacent curved wooden staves is configured to permit an exchange of gas between the content of the wooden bottle and the environment outside the wooden bottle.

12. The method of claim 11, wherein the bottle has a capacity between about 700 mL and about 2 L.

13. The method of claim 11, wherein the curved wooden staves are curved outwardly along the longitudinal axis of the wooden bottle to form a bilge on the bottle body.

14. The method of claim 11, where the curved wooden staves are curved along a circumference of the wooden bottle.

15. The method of claim 11, further comprising carving individual pieces of wood to form individual curved wooden staves.

16. The method of claim 11, further comprising treating the wood of the curved wooden staves with heat to facilitate aging of the content of the wooden bottle.

17. The method of claim 11, further comprising treating the wood of the curved wooden staves with open flame to facilitate aging of the content of the wooden bottle.

18. The method of claim 11, further comprising transferring a hot fluid, hot gas, or a combination thereof into the bottle body to cause the curved wooden staves to expand to seal the seams between adjoining curved wooden staves from leaks of the content of the wooden bottle.

19. The method of claim 11, wherein the curved wooden staves are configured to allow passage of a gas through the wood of the curved wooden staves.

20. The method of claim 11, further comprising carving the curved wooden staves from oak.
